(19) United States
(12) Patent Application Publication
(10) Pub. No.: US 2010/0136508 A1
(43) Pub. Date: Jun. 3, 2010

(54) Meal Plan Management

(76) Inventor: Damir Zekhtser, San Francisco, CA (US)

Correspondence Address: CARR & FERRELL LLP, 2200 GENG ROAD, PALO ALTO, CA, 94303, US

(21) Appl. No.: 12/604,872

(22) Filed: Oct. 23, 2009

Related U.S. Application Data
(60) Provisional application No. 61/108,009, filed on Oct. 23, 2008.

(51) Int. Cl. G09B 19/00

(52) U.S. Cl. 434/127

(57) ABSTRACT

A meal plan is generated based on user health data, goals and other information. The data regarding user health goals, eating habits, current health condition, and eating preferences is accessed. A user meal plan is then generated based on at least a portion of the accessed information. The meal plan may be modified based on user selected substitutions, automatically generated substitutions, or in some other manner. When the meal plan is modified, information related to the meal plan is updated.

### CROSS-REFERENCE TO RELATED APPLICATION

This application claims the priority benefit of U.S. provisional patent application No. 61/108,009 filed Oct. 23, 2008 and entitled “Meal Plan Management.” The disclosure of this application is incorporated herein by reference.

### FIELD OF THE INVENTION

The present invention generally relates to health management and more particularly to meal plan management and generating a meal plan for a user.

### BACKGROUND OF THE INVENTION

Maintaining healthy diet and exercise habits is essential to living a long and active life. Various sources of information including news articles, magazines, books, television, and the Internet are available to assist people with sustaining a nutritious diet and healthy lifestyle. Existing diet web services provide general health and diet information to a user. Information about healthy food choices and recipes, nutritional statistics, exercise routines, and exercise and calorie tracking methods is readily available. Some web services such as TheCalorieCounter.com or LiveStrong.com allow a user to track or record daily caloric intake, exercise activity, and weight. After a user provides information about consumed foods, these services provide nutritional information about the foods and calculate the number of corresponding calories consumed.

These services can be burdensome and time consuming, however, as the user continually has to provide information about the consumed foods. Nor are these services tailored to individual users to provide detailed, customized information based on the individual needs, health conditions, or preferences of a particular user.

There is a need in the art for a convenient service that easily provides nutrition and health information that is specific to the health and needs of a particular user, specifically with respect to food consumption and meal management for an individual user.

### SUMMARY OF THE INVENTION

Exemplary embodiments provide a mechanism for managing a meal plan. In some embodiments, data can be accessed regarding user health goals, eating habits, eating preferences and the current health condition of the user. A user meal plan is then generated based on at least a portion of the accessed information. In other embodiments, a meal plan may be generated without requiring user data. A meal plan may be modified based on other meal plans for people similar to the user or based on feedback received from a user. For example, feedback may be received from a user indicating that a meal should be changed to another user-selected meal. Feedback may also be received from a user indicating that a meal should be changed to another meal selected by the system. In both examples, the meal plan is changed and information associated with the meal plan, such as a number of calories, carbohydrates, grams of fat, and other information about the meal plan, is updated and displayed to the user.

In exemplary embodiments, a method for generating a meal plan for a user begins with receiving data associated with the user. A meal plan for the user is then generated based on the data and the meal plan is provided to the user through an interface. In some embodiments, user input may be received to modify the meal plan. A portion of the meal plan may be automatically replaced or deleted in response to receiving the input to modify the meal plan.

### BRIEF DESCRIPTION OF THE DRAWINGS

FIG. 1 illustrates an interface for receiving user health data used to generate a meal plan.

FIG. 2 illustrates an interface for allowing a user to provide input regarding favorite foods.

FIG. 3 illustrates an interface for allowing a user to provide input regarding disliked foods.

FIG. 4 illustrates an interface for indicating favorite foods selected by a user.

FIG. 5 illustrates an interface for allowing a user to search for, retrieve, and select favorite recipes.

FIG. 6 illustrates an interface for allowing a user to select favorite meals from restaurants.

FIG. 7 illustrates an interface for allowing a user to select favorite cuisines.

FIG. 8 illustrates an interface for providing meal plan information.

FIG. 9 illustrates an interface that provides information about a current meal plan for a user.

FIG. 10 illustrates information displayed within an interface in response to receiving user input selecting a particular day.

FIG. 11 illustrates an interface that shows a “Build a Meal Plan” tab currently selected.

FIGS. 12-16 illustrate embodiments of interfaces for managing and modifying a meal plan for a user.

FIG. 17 illustrates a system for authoring a protocol for identifying and processing user health data.

FIG. 18 illustrates a computing system that may be used to implement an embodiment of the present invention.

### DETAILED DESCRIPTION

Exemplary embodiments of the present meal plan management tool provide a mechanism for generating and managing a meal plan for a user. In some embodiments, a meal plan management tool accesses user information to generate a meal plan for a particular user. User information may include user health goals, eating habits, eating preferences, and current health condition. A user meal plan may then be generated based on at least a portion of the accessed information. The generated meal plan may include one or more recommended meals for a user to consume during a particular time period. The meal plan may correspond to a single meal or be a more extensive weekly or monthly meal plan.

The user meal plan may be modified based on other meal plans for people similar to the user, based on user feedback, or in response to other information. For example, the meal plan management tool may receive user feedback indicating that a particular meal should be changed to another meal that is selected by the user. As another example, user feedback may indicate that the user is instructing the meal plan management tool to randomly select an alternative meal for the user. In both examples, the meal plan is changed and information associated with the meal plan, such as the number of calories, carbohydrates, grams of fat, is updated and displayed to the user.

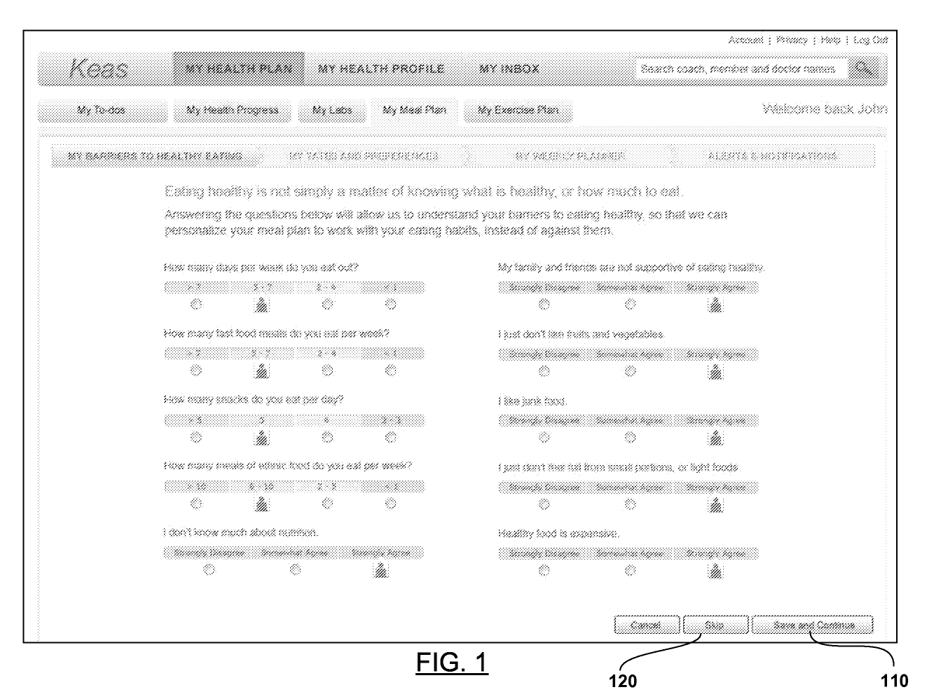

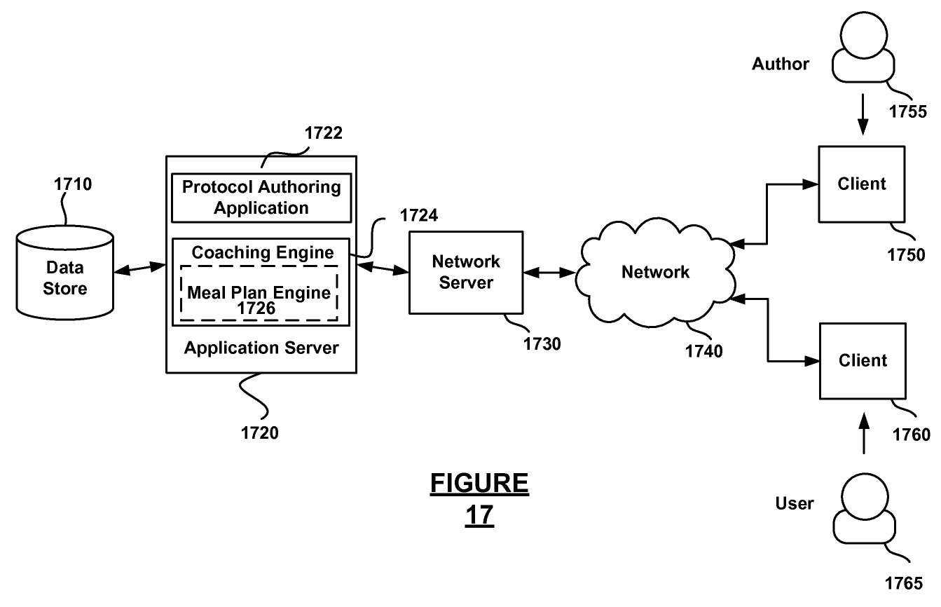

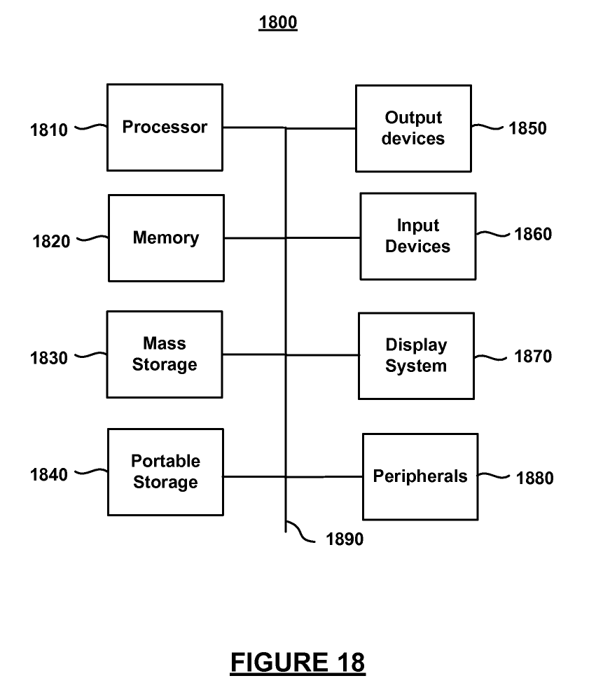

In some embodiments, the present meal plan management tool may be implemented by one or more processors that execute instructions stored in one more memory mediums. The executed code may result in the processors generating and providing one or more graphical interfaces. FIGS. 1-16 illustrate examples of interfaces used to implement embodiments of the present invention. An exemplary system and method for implementing the present meal plan management tool is described in the context of FIGS. 17 and 18 below.

FIG. 1 is an interface for receiving user health data used to generate a meal plan. The interface of FIG. 1 can be used to collect user health data, such as health goals, eating habits, current health condition or status, or user beliefs or opinions that can be used to generate a meal plan. The illustrated interface may prompt the user to answer one or more questions that can be answered by selecting a given answer choice. The data collected by the interface of FIG. 1 can include information such as how many days the user eats out, the number of fast food meals eaten per week, knowledge of nutrition, and preference for fruits, vegetables and junk food. The data collected may also include health goals for the user such as weight loss, weight gain, reduced Body Mass Index (BMI), and lower cholesterol levels.

The meal plan management tool may also collect user health data related to the current health status of the user including whether the user suffers from any medical conditions or ailments such as high cholesterol, diabetes, high blood pressure, arthritis, migraines, or food allergies. Once a user has answered a question or otherwise provided user health data, the user may prompt the meal plan management tool to save the information by selecting a “Save and Continue” button (110) as illustrated in FIG. 1. The meal plan management tool may then generate a meal plan for the user based on the received information.

In some embodiments, a user may forego inputting user health data by selecting a “Skip” button (120) as shown at the bottom of FIG. 1. The meal plan management tool may then generate a user meal plan without little or no user input. The meal plan management tool may then generate and provide a user with a standard or universal meal plan that is not based on health data provided by the user.

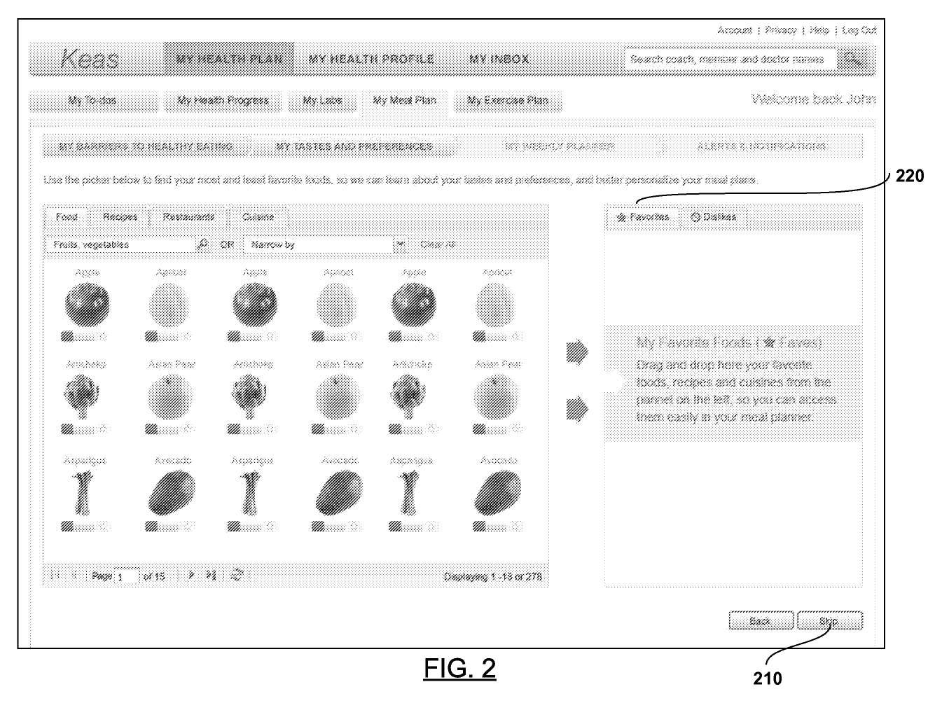

Once the meal plan management tool has received or accessed user health data, such as user health goals, eating habits, and medical conditions, the meal plan management tool may receive further user data regarding preferred and disliked foods for the user. FIGS. 2-7 illustrate interfaces for receiving user input regarding preferred and disliked food and meal data. As with user health data, a user may forego selecting preferred or disliked foods by selecting a “Skip” button (210) as shown at the bottom of FIG. 2. In some embodiments, the meal plan management tool may generate a user meal plan without requiring a user to provide data regarding preferred or disliked foods.

FIG. 2 is an interface for allowing a user to provide input regarding favorite foods. Through the illustrated interface, a user can select fruits and vegetables to be identified as “favorites” by ‘dragging and dropping’ those favorite selections into the designated “Favorites” area (220). Other methodologies for selection such as ‘ticking’ boxes and double clicking an item may be used. After one or more favorite foods have been identified by the user, the system can generate a meal plan based on favorite foods of the user. The meal plan for a user may be customized to the foods identified as favorites of the user. The present system may also group or organize foods in different categories such as “fruits,” “vegetables,” “grains,” “dairy,” “rice and pasta,” “meats and protein,” “sweets,” or any other category or combination thereof. Foods may further be grouped by type of cuisine such as American, French, and Asian.

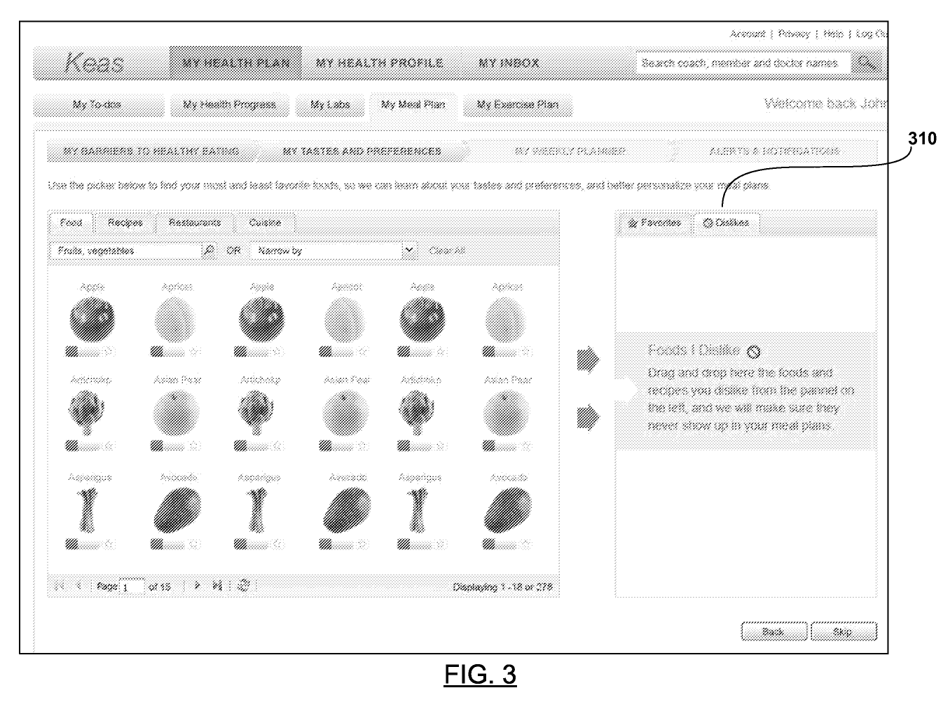

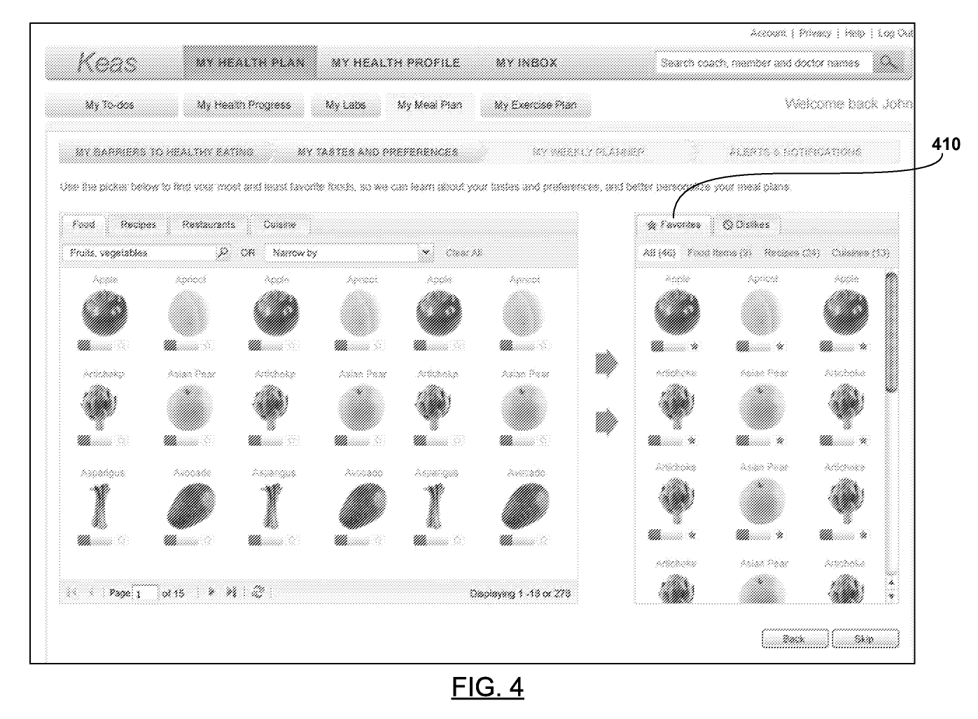

Additionally, as illustrated in FIG. 3, the system may provide an interface for allowing a user to provide input regarding disliked foods (310). A food identified by a user as being disliked will, if possible, not be incorporated into the meal plan for that user by the system. In an embodiment like that disclosed in FIG. 4, after a user has “dragged and dropped” several food icons into a portion of the interface associated with favorite foods, icons representing those foods will be displayed in the “Favorites” portion of the interface (410). A similar listing may appear with respect to disliked foods. The meal plan management tool may also allow a user to identify other favorite and disliked food items, recipes, restaurants, cuisines, and other categories of foods.

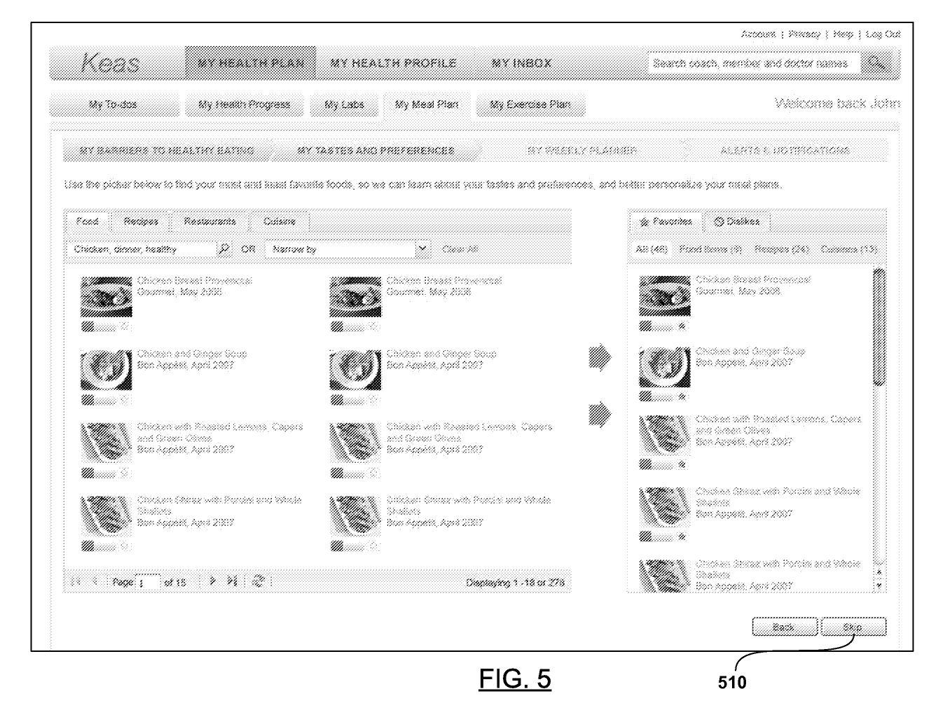

FIG. 5 illustrates an interface for allowing a user to search for, retrieve, and select favorite recipes stored in the memory of the meal plan management tool, such as different recipes associated with the key words of “chicken, dinner, healthy.” The user may also search for a recipe by type of cuisine. A user may also manually enter or update the meal management tool to include a recipe not otherwise found in the tool. A manually entered recipe may be stored in memory for future use. A user may bypass selecting favorite recipes by selecting a “Skip” button (510) as shown at the bottom of FIG. 5. In some embodiments, the meal plan management tool may generate a user meal plan without requiring a user to provide a favorite recipe.

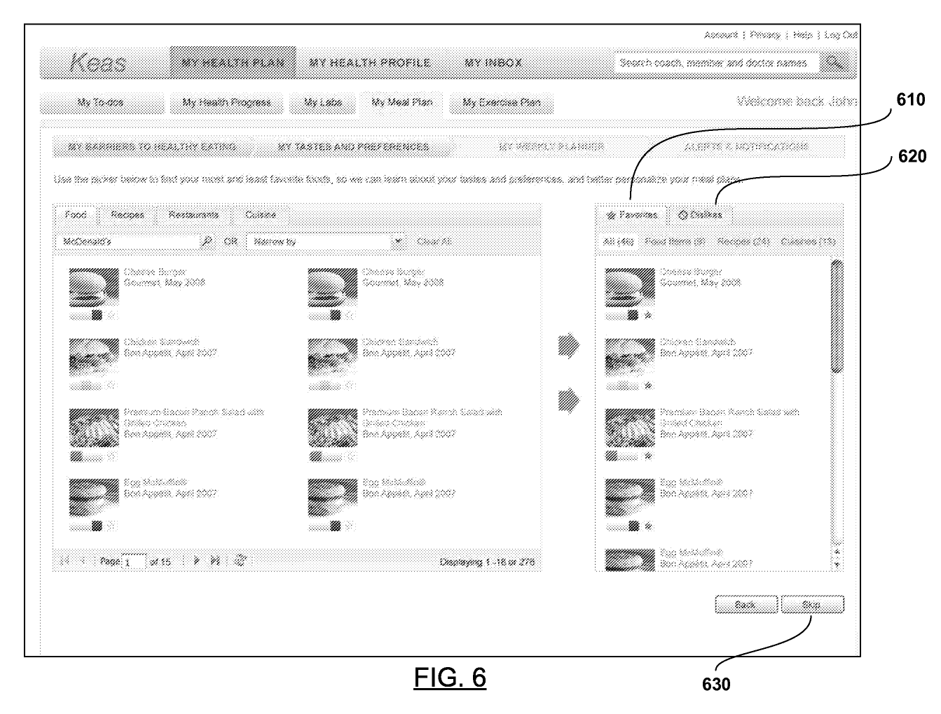

FIG. 6 illustrates an interface for allowing a user to select favorite meals from restaurants. A user may also select favorite meals or foods available at establishments that offer meals such as formal dining establishments, fast food restaurants, cafes, supermarkets, convenience stores, coffee shops, smoothie or drink shops, bars, or concession stands. A selected meal from a restaurant is displayed in the “Favorites” portion of the interface (610) while a disliked meal is displayed in a listing of “Dislikes” (620).

If the user has searched but cannot locate a particular restaurant or food establishment by a keyword search in the system, the user may manually input the name of the restaurant and the food consumed. The user may also enter known nutritional statistics associated with the food consumed. In some embodiments, the meal management tool may calculate or provide an estimate of nutritional statistics based on extrapolations from similar foods or known nutritional information. A manual entry by the user or as calculated by the tool may be stored for future selection. Manually entered or derived meal plan information may be associated with corresponding types of cuisine or other meal plan data. A user may bypass selecting a favorite meal from a restaurant by selecting a “Skip” button (630) as shown at the bottom of FIG. 6. In some embodiments, the meal plan management tool can generate a user meal plan without requiring a user to provide a favorite restaurant meal.

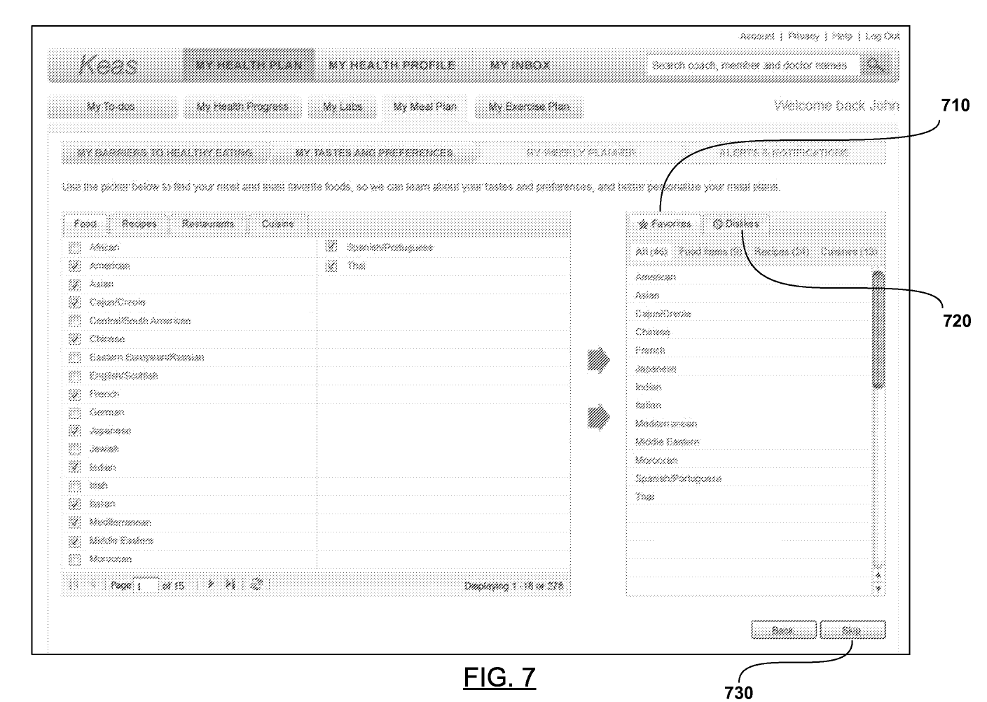

FIG. 7 illustrates an interface for allowing a user to select a favorite cuisine, such as African, Asian, German, Italian, and so forth. Using a ‘ticking’ method, a user selects a favorite cuisine from a list of different cuisines as illustrated in FIG. 7. Other methods for selection such as double clicking or ‘dragging and dropping’ may be used. A marked cuisine is displayed in the “Favorites” portion (710) of the interface. A selection of disliked cuisines may also occur and be displayed in a listing of “Dislikes” (720). The meal plan management tool may then generate a meal plan based on a favorite or disliked cuisine of the user.

As with selecting favorite restaurant meals, a user may manually enter a type of cuisine not found in the list of cuisines. If the user has searched but cannot locate a particular cuisine by a keyword search in the system, the user may manually input the type of cuisine. A manual entry by the user may be stored for future selection. A user may also bypass selecting a favorite or disliked cuisine by selecting a “Skip” button (730) as shown at the bottom of FIG. 7. In some embodiments, the meal plan management tool may generate a user meal plan without requiring a user to provide a favorite cuisine.

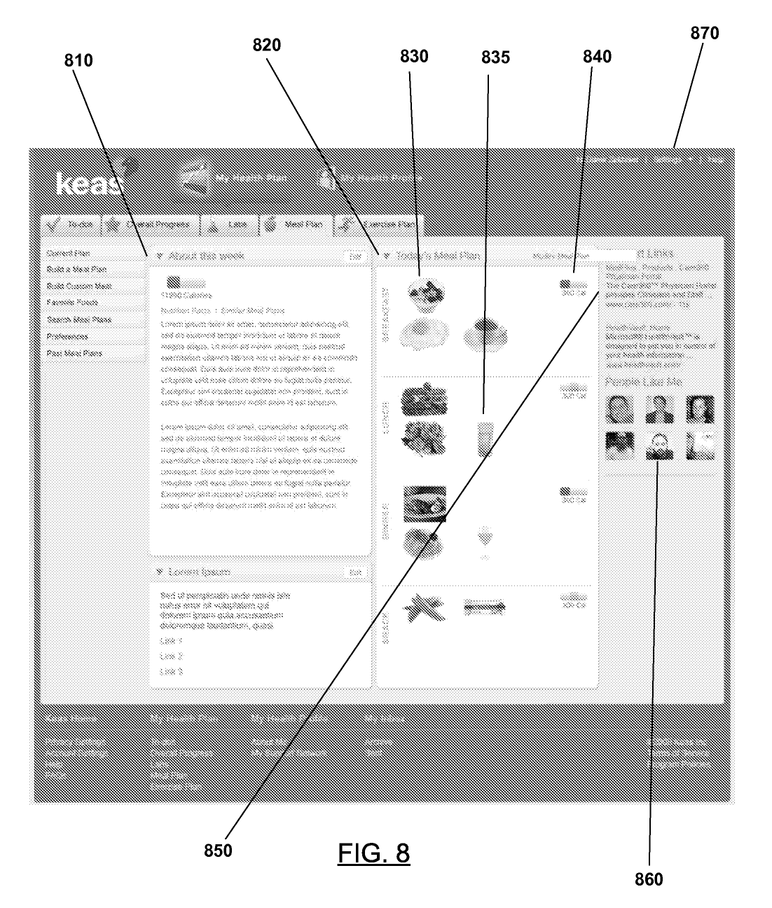

The interfaces in FIGS. 1-7 for receiving user input are not limited to the order or arrangement presented. A user may provide, and the meal plan management tool may collect and receive, user health data and data regarding the preferred or disliked foods, recipes, restaurants, and cuisines in any order. After gathering user data and meal preferences and/or dislikes, the meal plan management tool generates a meal plan for the user. A generated meal plan may provide suggested meals for a single day, one week, one month, or any other length of time as may be identified by the user. FIGS. 8-16 illustrate exemplary interfaces that may be used to interactively provide meal plan information to a user.

Any of several meal plans can be utilized by a user. For example, a user may utilize a generated standard or universal meal plan that is not based on a specific user. A user may alternatively adopt a basic plan generated for the user based on the user input, such as health goals, eating habits, or user food preferences and dislikes. The user may also choose to utilize a slightly modified plan generated for people similar to the user, or a plan that is customized by the user. For example, after providing the user with a basic plan, the meal plan management tool may receive input from the user to change a portion of the plan specifically as directed by the user, in accordance with meal plans generated with people similar to the user, or some other way.

FIG. 8 illustrates an interface for providing meal plan information. The meal plan information provided in FIG. 8 includes an overview of the meal plan for the current week (810) and information about the meal plan for the current day (820). The meal plan for the day includes icons representing the recommended foods (830-835) for the day and the amount of calories associated with each meal (840). The interface of FIG. 8 may also include links to relevant diet, exercise and health information, products and advertisements (850), and may also display other users (860) of the meal plan management tool who have similar interests, meal plans or health information to that of the user. The interface of FIG. 8 also includes several tabs, icons, or other selectable elements that initiate a process for building a meal plan, modifying a meal plan, identifying favorite foods, accessing other information, or initiating other tasks and features of the meal plan management tool. The user may also change the settings of the interface by accessing a “Settings” feature (870). For example, the user may instruct the meal plan management tool to display the interface in a particular language (e.g., English, French, Spanish or German).

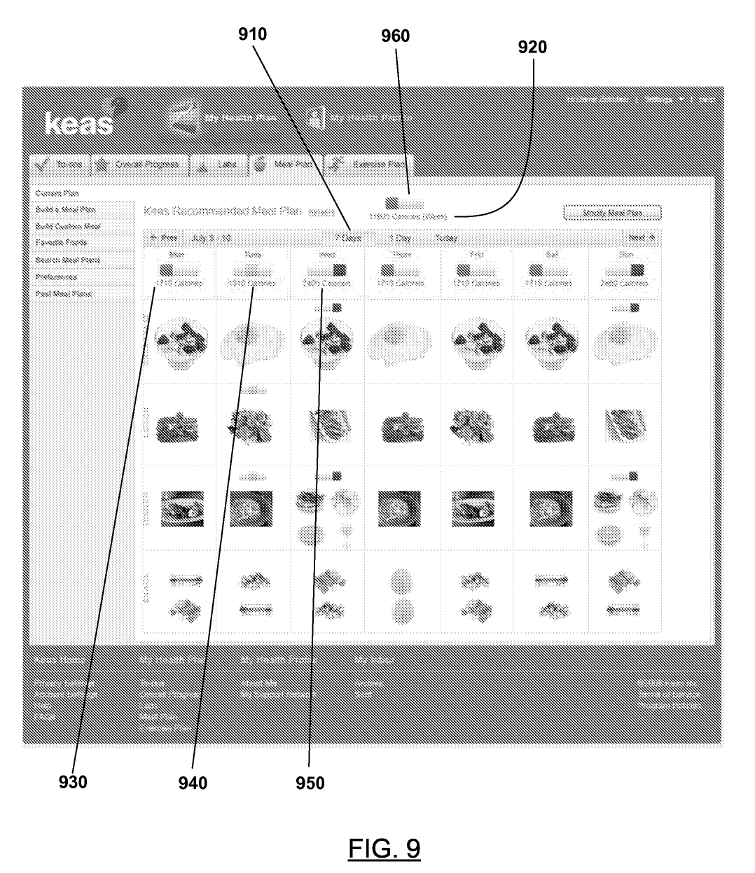

FIG. 9 illustrates an interface that provides information about a current meal plan for a user. The interface of FIG. 9 illustrates the recommended meal plan information for a seven day period (910) and the number of calories associated with the meal plan (920). The meal plan may be displayed for other time periods such as a single day, a future day, a future week, or some other time period indicated by the user. For each day in the meal plan, the interface of FIG. 9 illustrates icons associated with the scheduled meals—breakfast, lunch, dinner and snack. A food icon or graphic, or any other type of picture or symbol may be associated with each type of meal, food, dish or restaurant for easy and fast user identification or association. In FIG. 9, an icon or group of icons is used to represent a meal. An image of a sandwich for lunch is illustrated on Monday, Thursday, and Saturday while an image of a chicken dish is illustrated for dinner on Monday and Friday.

The interface in FIG. 9 also provides an indicator as to a general rating for the level of health for the planned meals for each day. The icon for the Monday meal plan (930) has a green colored indicator associated with a healthy level whereas the icon for the Tuesday meal plan (940) is yellow indicating that the meal is somewhat healthy level. The icon for the Wednesday meal plan (950) is red indicating an unhealthy level. For daily meal plans that are not considered healthy, a further indicator may be associated with the particular meal for that day that detracts from the healthy rating. For example, in the Wednesday meal plan, a red colored icon is associated with the planned breakfast meal and dinner meal indicating that these meals are unhealthy and contribute to the overall unhealthy level of the Wednesday meal plan. The overall health level of the meal plan for the week (960) may also be indicated—the green indicator representing the health level of the current week as “healthy” is positioned near the top of the meal plan in FIG. 9.

Besides using a color-coded indicator of a health level, the health level for a particular meal or time period (e.g, day, week, or month) may be alternatively illustrated by a score, bar graph, meter, symbol, or any other static, moving, or flashing graphic or icon. The meal plan management tool may also be configured to send an alert or warning to the user via electronic mail, text, or other method. For example, an alert or warning may be sent to the user if the meal plan for a particular meal, day, or week has reached an unhealthy level. An alert may also be sent if the user has reached a health goal such as the meal plan being low in fat or calories for a certain time period.

As discussed above, a meal plan may be generated based on user goals and/or current medical condition. The health level of the meal plan may also or alternatively be determined based on how well the meal contributes to the health goals of the user as well as the value to the user based on the current health condition of the user. For example, if a user has high blood pressure, a meal with a high cholesterol or saturated fat level may be determined to be undesirable (i.e., red level) while those with a lower cholesterol or saturated fat level may be desirable (i.e., green level). Similarly, if a user is trying to lose weight, a meal with a high level of calories may be undesirable (i.e., red level) while a meal with a low level of calories may be desirable (i.e., green level).

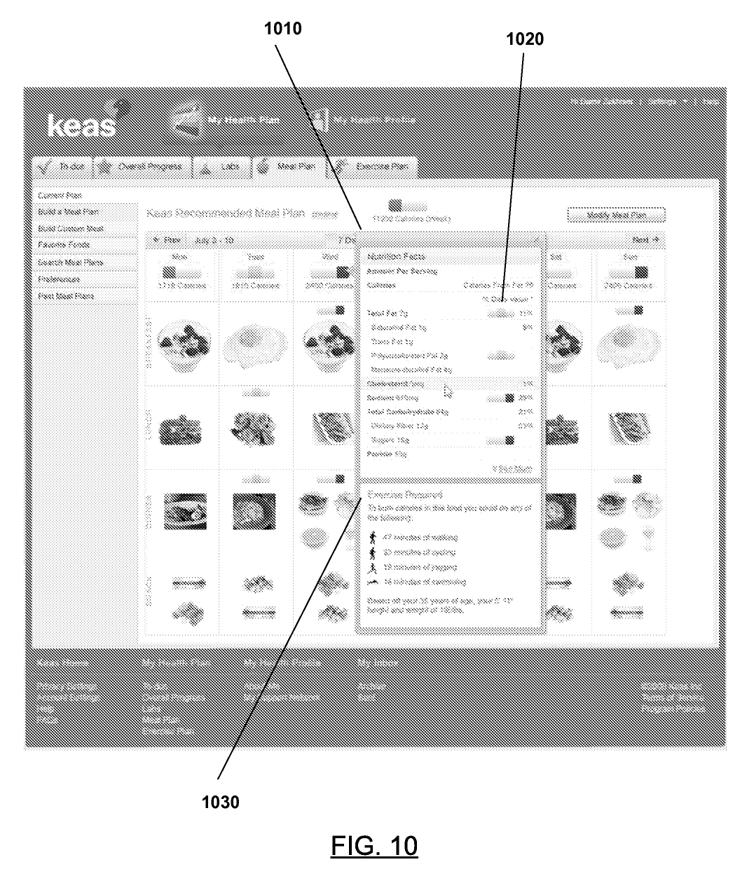

In addition to providing the health level information associated with an entire day or week, health information can also be provided based on ingredients consumed for a meal or day. FIG. 10 illustrates information displayed within an interface in response to receiving user input selecting a particular day. The information may indicate the nutritional composition of the meal plan for the day (1010) and the health levels of the meal components (1020). For example, the information may indicate that the total fat and polyunsaturated fat for the meal plan are at somewhat unhealthy or “yellow” levels and that sodium and sugars are at unhealthy or “red” levels for the meal. The information may also indicate examples of the exercise needed to burn off the calories consumed with the meal plan highlighted as calculated by the meal management tool (1030). The information reflected in FIG. 10 indicates that burning off the calories for the day selected would require 47 minutes of walking, 33 minutes of cycling, 19 minutes of jogging or 14 minutes of swimming.

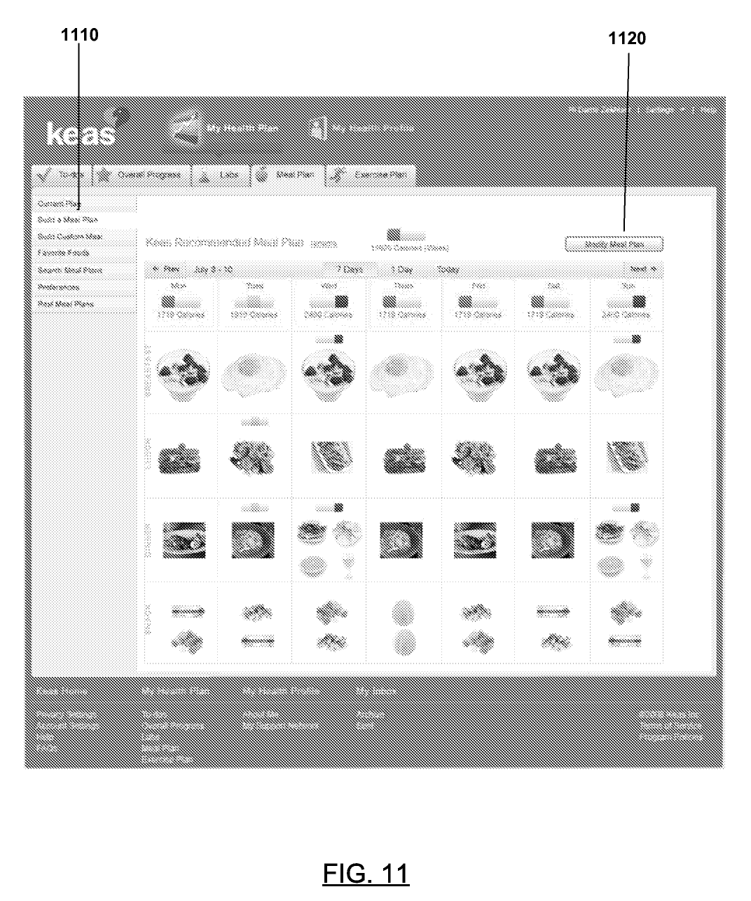

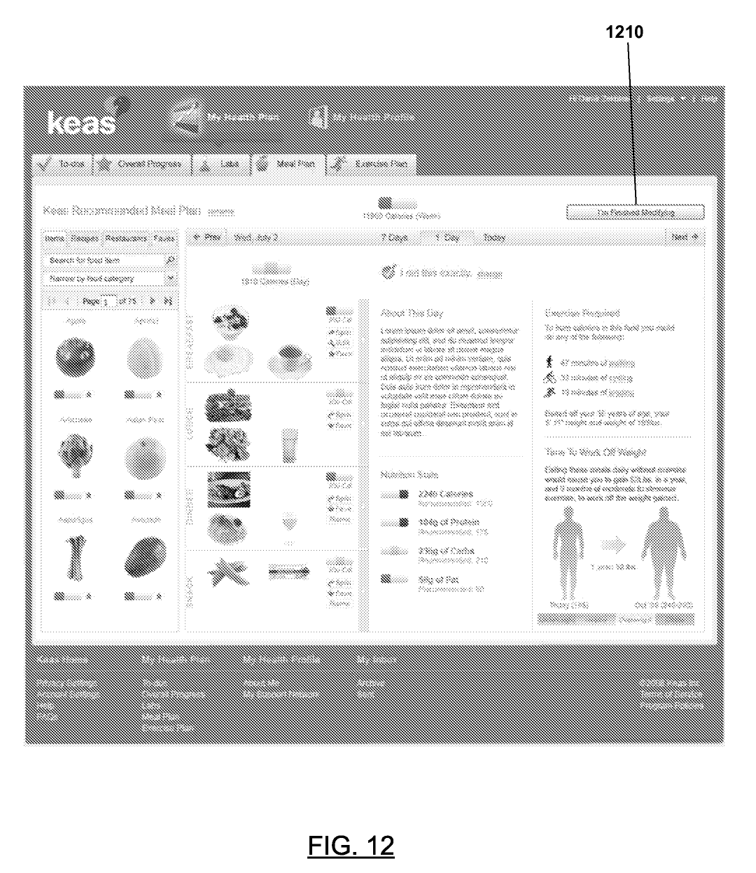

After a meal plan has been generated for a user, the meal plan may be modified. FIG. 11 illustrates an interface that shows a “Build a Meal Plan” tab currently selected (1110). The meal management tool may receive input indicating that a user would like to modify the meal plan. FIG. 11 includes a “Modify Meal Plan” button (1120) that a user can select to begin modifying the current meal plan. Once the user has completed a modification to the meal plan, the user can select the “I'm Finishing Modifying” button as illustrated in FIG. 12 (1210).

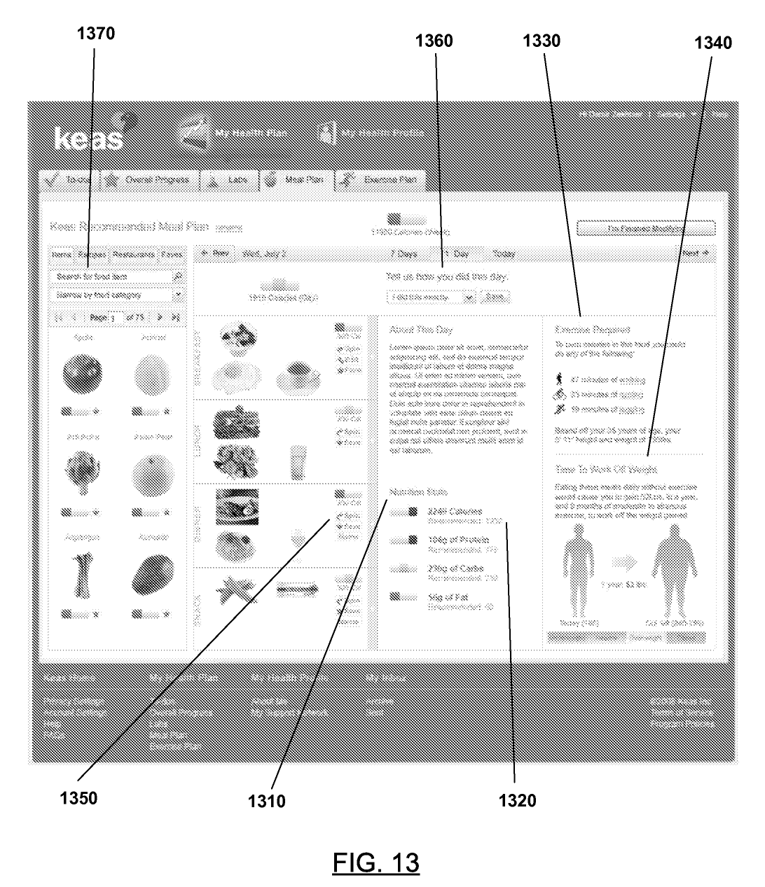

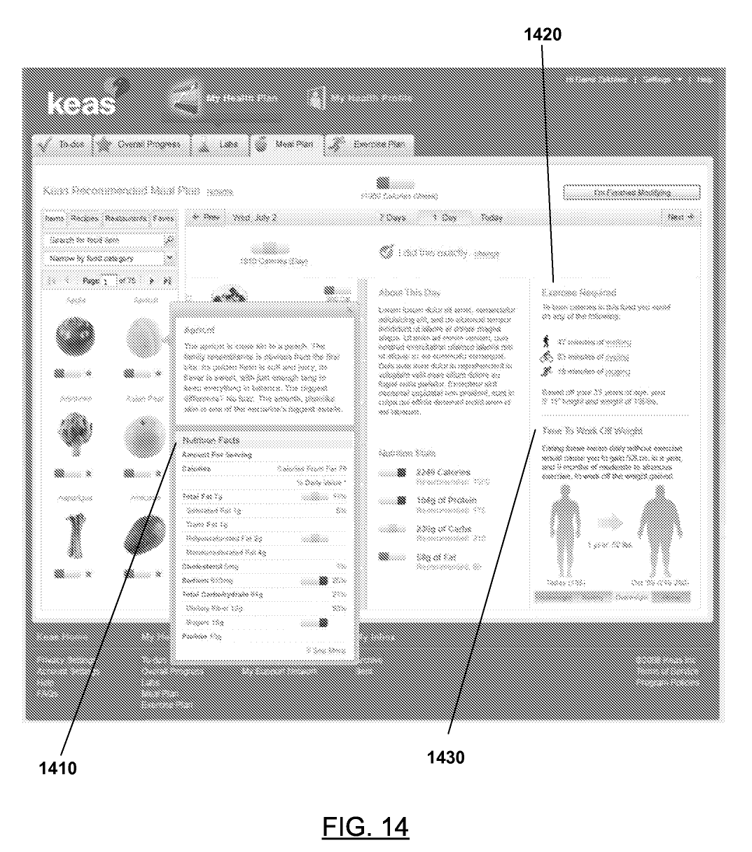

FIGS. 12-16 illustrate interfaces for managing and modifying a meal plan for a user. The interfaces of FIGS. 12-16 illustrate information related to the meal plan for the current day, nutritional statistics for the meal plan, exercise required to burn off the calories in the meal plan, and an estimate of the consequences in weight gain if no exercise is performed. The interfaces may display the nutritional statistics associated with a particular daily meal plan (1310) as illustrated in FIG. 13, or with a component or ingredient of a meal plan (1410) as illustrated in FIG. 14. The nutritional statistics provided include meal plan calories, protein, carbohydrates and fat associated with the selected meal plan. Additional nutritional statistics, such as those related to fiber, sugar, sodium or cholesterol, may also be displayed.

The nutritional statistics of a particular meal plan may also be displayed and compared to the daily recommended nutritional values (1320) as illustrated in FIG. 13. As shown in FIGS. 13-16, the interfaces further display one or more suggested types of exercise routines and estimates of the duration of each type of exercise required to burn off the calories in the meal plan (1330, 1420, 1510, 1620). Weight gain consequence information (1340, 1430, 1520, 1630) may also be displayed and may be based on the health information of the user such as age, gender, height, and weight or habits and other information. Weight gain consequence information may indicate the weight gain that could result if the daily meal plan was consumed for a year, month, or some other time period, without performing the suggested exercise routines.

A user may modify a meal plan by adding a specified meal component to the current meal plan. A user may modify the current meal plan by performing a ‘drag and drop’ operation of an icon representing a favorite item, recipe, restaurant, or some other meal component to a portion of the interface associated with the particular meal to be modified. When the ‘drag and drop’ operation to modify the meal plan is completed, the meal plan will automatically be updated with new health level information, calorie-burn off information, and nutritional statistics.

The meal plan may also be modified to substitute one or more meals not specifically identified for a user. Input may be received from a user to change the breakfast for a particular day, such as by selection of an icon within an interface. An automatic meal substitution may occur after the system receives user input such as through selecting the “spin” button (1350) associated with a particular meal.

By selecting the “spin” button associated with a particular meal, the user instructs the meal plan management tool to substitute or change the currently selected meal option with an alternative meal option. The alternative meal may comply with requirements associated with the user preferences and dislikes, the user goals, and the current health condition of the user to provide a healthy or “green level” meal for the user. The meal substitution feature can be used to randomly select alternate meals for a particular meal, an entire day, an entire week, or some other set of meals. Upon substituting the meals, the meal plan is automatically updated with health level information, calorie-burn off information, and nutritional statistics.

The meal plan may also be modified after a user has consumed a meal and has not exactly followed the meal plan. As illustrated in FIG. 13, a user indicates whether or not the daily meal plan was followed by making a selection from a drop-down menu (1360). The user can indicate “I did this exactly” or “I did not do this exactly.” Besides a drop-down menu, other methodologies for selection can be used such as ‘ticking’ boxes or double clicking the selection. For example, if the meal plan recommended a turkey sandwich for the lunch meal but the user instead had a cheeseburger, the user can update the meal plan with the meal that was actually consumed.

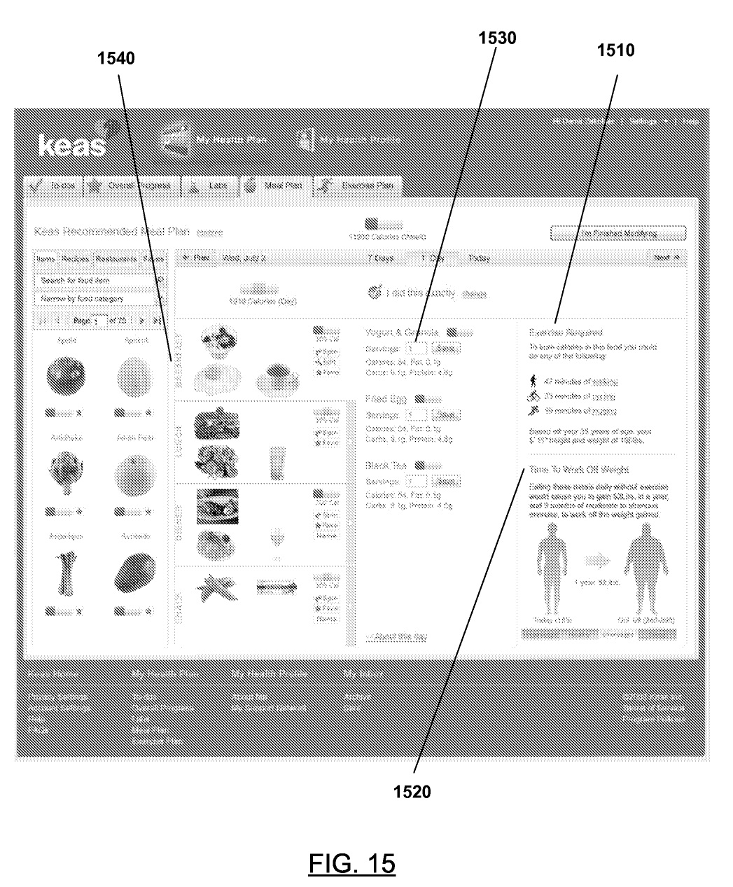

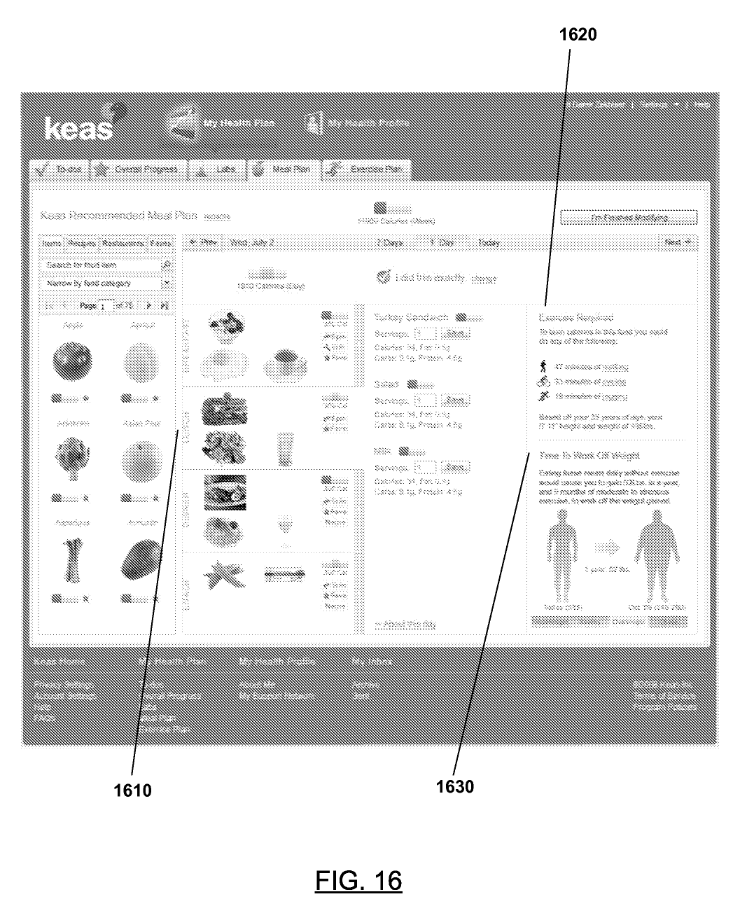

After indicating that the user did not follow the meal plan exactly, the user can proceed to update the meal plan by selecting the particular day and using the ‘drag and drop’ operation to select a meal for substitution. Alternatively, the user can select and retrieve the substituted meal by a keyword search (1370). Once the user has a selected a meal for substitution, the user can indicate the number of servings or portion consumed as illustrated in FIG. 15 (1530). In FIG. 15, the interface shows the breakfast meal tab selected for modification (1540) and the nutritional statistics associated with the meal. In FIG. 16, the lunch meal tab (1610) is selected for modification.

After the meal plan modification is completed, the meal plan will automatically be updated to show the meal plan with corresponding food icons and display the new health level information, calorie-burn off information, and nutritional statistics. In addition to generating a meal plan for a user, the meal plan management tool may be able to track past meals and display the associated health level information, calorie-burn off information, and nutritional statistics for a given time period (e.g., current day, single day, one week, or one month).

Meal plan data can be processed by a meal plan coaching engine to generate a meal plan for a user. Embodiments of the present meal plan management tool allow for identification of user meal plan data and performing actions based on such data. A meal plan coaching engine executed within a meal plan coaching protocol may be configured for identifying and processing user health data. The meal plan coaching engine may perform actions to provide a user with information, meal plan recommendations, alerts, and appointments with other users of the system, health coaches, mentors or health care professionals. The meal plan coaching engine may also predict attribute values for a user based on a time period and goals for user health data upon which the predicted attribute value is based.

The presently disclosed management tool and coaching engines are flexible in that they consider information from a variety of sources for meal plan management. The protocol may incorporate physical, social, family, and other health related data of the user. The protocol may process both singularly occurring actions as well as those that occur repeatedly over time and that may be based on observed trends. Feedback regarding meal plan management may be provided to a user based on the most recent user data as well as progress—good or bad—made by the user.

FIG. 17 is an exemplary system for authoring a protocol for identifying and processing user health data. The system of FIG. 17 includes data store 1710, application server 1720, and network server 1730.

Data store 1710 stores user health data including attribute, protocol, goal, and other data. Data store 1710 can be implemented as a logical data store on the same computing device as coaching engine 1724, as one or more separate machines accessible by coaching engine 1724, or a combination of the foregoing. The user health data can also include information about the health goals of the user, health knowledge and opinions, eating habits such as frequency of meals or snacks, and food preferences including likes and dislikes. The user data can further include other health data for a user including but not limited to user age, weight, birthday, gender, height, blood pressure, stress level, sleep habit information, nutrition information, alcohol consumption, smoking habits, food allergies, hemoglobin data, HDL, LDL and whether the user suffers from any medical conditions such as diabetes, high blood pressure, high cholesterol, or arthritis.

Application server 1720 may be implemented in a general computing device that otherwise communicates with data store 1710 and network server 1730. An example of such a device is the general computing system illustrated in FIG. 18. Application server 1720 as illustrated in FIG. 17 includes protocol authoring application 1722 and coaching engine 1724. Protocol authoring application 1722 may by executed by a processor to provide interface data concerning a graphical interface to a client device (e.g., client 1750). This interface data may then be executed and rendered as an interface by a client 1750 application such as a web browser or Java Virtual Machine. The interface generated from the interface data can be used by author 1755 at client 1750 for authoring a protocol related to meal plan management. The protocol authoring interface as generated from execution of the protocol authoring application 1722 can include HTML, XML, scripts, or other code for rendering an authoring interface at client 1750. Exemplary interfaces generated from interface data are illustrated in FIGS. 8-16.

Coaching engine 1724 may be stored in memory and is executable by a processor (not shown) at application server 1720 to administer a user meal plan coach protocol, where the administration includes generation and management of meal plans, user attributes, goals, and rules. Attributes, goals, and rules can be configured in response to input data received from an author 1755 at client 1750. Coaching engine 1724 may be implemented as or may invoke a meal plan engine 1726, which executes on user health data to identify user meal plan data and perform actions based on the data including generating a meal plan for a user. The meal plan engine 1726 may be its own independent engine or integrated as a functional part of coaching engine 1724.

Protocol authoring application 1722 is executed at the application server 1720 to access, process, and transmit interface data to client 1750 via network server 1730 and network 1740. The client 1750 receives the interface data over network 1740 and renders an interface from the interface data in a browser application or other client application, which provides the interface to an author 1755. The client 1750 may then receive input from an author 1755 and transmit input data based on the input to coaching engine 1824 and/or meal plan engine 1726 on application server 1720 or data store 1710 over network 1740 and network server 1730. The input data can include the received input, or data identifying the input, as well as routing information for data packets intended for coaching engine 1724 and/or meal plan engine 1726. An example of a method for creating a coaching protocol is discussed in U.S. patent application Ser. No. 12/360,731, filed Jan. 27, 2009, and entitled “Protocol Authoring for a Health Coaching Service,” the content of which is incorporated herein by reference.

Coaching engine 1724, which may include the functionality of meal plan engine 1726, may access user health data from data store 1710 and process the user health data to perform actions. The user health data may be retrieved and used to populate one or more interfaces. Moreover, data received as input by a client 1750 may be transmitted to coaching engine 1724 and/or meal plan engine 1726 and stored in data store 1710. Data input by a client 1750 may include user health data, types of food, meals, recipes, restaurants, cuisines, or nutritional statistics associated with a particular food or meal.

Coaching engine 1724 can process the user health data, attributes and rules to provide alerts, suggestions, updated goals, status and calculated attributes, and other content for a user 1765. For example, coaching engine 1724 can include or invoke the aforementioned meal plan engine 1726, which receives user meal plan data indicating user food consumption trend and adjusts a predicted life span value and weight prediction value for the user based on the user food consumption data. The content can be provided to a user through a coaching interface provided through client 1760. Coaching engine 1724 may also calculate nutritional statistics associated with a particular meal portion. Coaching engine 1724 may also determine the health level of one or meals in a meal plan. An example of a method for executing a protocol by a coaching engine is discussed in U.S. patent application Ser. No. 12/434,574, filed May 1, 2009 and entitled “Coaching Engine for a Health Coaching Service,” the content of which is incorporated herein by reference.

User 1765 at client 1760 may perform a login with a service provided by coaching engine 1724 and receive interface data as a browser application content page. The interface data may include any updates for the user meal plan status, including updated user health data, attribute values, and results of executed rule expressions. The interface data may additionally include information generated through the execution of the meal plan engine 1726 such as predicted weight data for the user based on current user consumption trends, such as the predicted weight data shown in FIGS. 12-16.

Network 1740 is inclusive of any communication network such as the Internet, Wide Area Network (WAN), Local Area Network (LAN), intranet, extranet, private network, or other network. Application server 1720 may be accessed via network server 1730. Network server 1730 can receive and process requests from clients 1750-1760. Processing the requests may include sending a request to coaching engine 1724 on application server 1720, receiving a response from coaching engine 1724, or forwarding that response to a requesting client.

Clients 1750 and 1760 are inclusive of a general purpose computing device capable of accessing information over a network like that illustrated in FIG. 18. Client 1750, specifically, can generate the input data based on input received from author 1755. Input data may be received at the client 1750 through an interface generated from interface data received from execution of the protocol authoring application 1722 over network 1740.

Clients 1750 and 1760 may be implemented as computing devices such as workstations, servers, lap top computers, mobile devices, or other computing devices that can communicate over network 1740. Client 1750 may include a browser application for rendering coach protocol authoring interface data as a web page interface. Client 1760 may include a browser application for rendering coach interface data as web pages interfaces for accessing user health updates and content.

FIG. 18 illustrates an exemplary computing system 1800 that may be used to implement an embodiment of the present invention. System 1800 of FIG. 18 may be implemented in the contexts of the likes of data store 1710, application server 1720, network server 1730, and clients 1750-1760. The computing system 1800 of FIG. 18 includes one or more processors 1810 and memory 1820. Main memory 1820 stores, in part, instructions and data for execution by processor 1810. Main memory 1820 can store the executable code when in operation. The system 1800 of FIG. 18 further includes a mass storage device 1830, portable storage medium drive(s) 1840, output devices 1850, user input devices 1860, a graphics display 1870, and peripheral devices 1880.

The components shown in FIG. 18 are depicted as being connected via a single bus 1890. However, the components may be connected through one or more data transport means. For example, processor unit 1810 and main memory 1820 may be connected via a local microprocessor bus, and the mass storage device 1830, peripheral device(s) 1880, portable storage device 1840, and display system 1870 may be connected via one or more input/output (I/O) buses.

Mass storage device 1830, which may be implemented with a magnetic disk drive or an optical disk drive, is a non-volatile storage device for storing data and instructions for use by processor unit 1810. Mass storage device 1830 can store the system software for implementing embodiments of the present invention for purposes of loading that software into main memory 1820.

Portable storage device 1840 operates in conjunction with a portable non-volatile storage medium, such as a floppy disk, compact disk or Digital video disc, to input and output data and code to and from the computer system 1800 of FIG. 18. The system software for implementing embodiments of the present invention may be stored on such a portable medium and input to the computer system 1800 via the portable storage device 1840.

Input devices 1860 provide a portion of a user interface. Input devices 1860 may include an alpha-numeric keypad, such as a keyboard, for inputting alpha-numeric and other information, or a pointing device, such as a mouse, a trackball, stylus, or cursor direction keys. Additionally, the system 1800 as shown in FIG. 18 includes output devices 1850. Examples of suitable output devices include speakers, printers, network interfaces, and monitors.

Display system 1870 may include a liquid crystal display (LCD) or other suitable display device. Display system 1870 receives textual and graphical information, and processes the information for output to the display device.

Peripherals 1880 may include any type of computer support device to add additional functionality to the computer system. For example, peripheral device(s) 1880 may include a modem or a router.

The components contained in the computer system 1800 of FIG. 18 are those typically found in computer systems that may be suitable for use with embodiments of the present invention and are intended to represent a broad category of such computer components that are well known in the art. Thus, the computer system 1800 of FIG. 18 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for generating a meal plan for a user, comprising:
executing instructions stored in memory, wherein execution of the instructions by a processor:
collects health data from a user,
accesses the collected user health data,
generates a meal plan based on the collected user health data, wherein the meal plan includes nutritional statistics about one or more components of a meal; and
displaying the generated meal plan on an interface of a client device.

2. The method of claim 1, further comprising modifying the meal plan by substituting one or more meals of the meal plan with an alternative meal.

3. The method of claim 2, wherein the alternative meal is randomly selected.

4. The method of claim 2, wherein the alternative meal is selected based on user feedback.

5. The method of claim 1, further comprising modifying the meal plan by adding one or more meals to the meal plan, the added meal based on user feedback.

6. The method of claim 1, wherein the meal plan further includes a suggested exercise routine associated with the daily meal plan.

7. The method of claim 1, wherein the meal plan includes one or more indicators of a health level, the health level indicating whether the meal plan is healthy, somewhat healthy, or unhealthy.

8. The method of claim 7, wherein the health level is based on the health condition of the user.

9. The method of claim 6, wherein the meal plan further includes a predicted weight gain by the user when the suggested exercise routine is not performed.

10. A system for generating a meal plan for a user, comprising:
a data store configured to store user health data, and
a coaching engine stored in memory and executable by a processor to:
collect user health data from a user,
access the collected user health data,
process the accessed user health data; and
generate a meal plan for the user based on the user health data, wherein the meal plan includes nutritional statistics about one or more components of a meal.

11. The system in claim 10, wherein the coaching engine is configured to calculate a nutritional statistic associated with a component of a meal.

12. The system in claim 10, wherein the coaching engine is configured to determine a health level associated with a meal, the health level based on a health condition of the user.

13. The system in claim 10, wherein the coaching engine is configured to modify the generated meal plan based on user input.

14. The system of claim 10, wherein the coaching engine is configured to send an alert to the user, the alert indicating the current health level of the meal plan.

15. A computer-readable storage medium having embodied thereon a program, the program being executable by a processor to perform a method for generating a meal plan for a user, the method comprising:
collecting health data from a user,
accessing the collected user health data,
generating a meal plan based on the collected user health data, wherein the meal plan includes nutritional statistics about one or more components of a meal; and displaying the generated meal plan on an interface of a client device.
